(19) United States
(12) Patent Application Publication
(10) Pub. No.: US 2007/0057773 A1
(43) Pub. Date: Mar. 15, 2007

(54) Apparatus and Methods of Universal Radio Frequency Identification Sensing System

(75) Inventors: PingFu Hsieh, Tainan (TW); TsaiHeng Su, Tainan (TW); JuiLi Sun, Kaohsiung (TW)

Correspondence Address: BEEDAR TECHNOLOGY INC., R206, #12, NAN-KE 2ND ROAD,, TAINAN SCIENCE-BASED INDUSTRIAL PARK, TAINAN, TW

(73) Assignee: BEEDAR TECHNOLOGY INC., Tainan (TW)

(21) Appl. No.: 11/162,410

(22) Filed: Sep. 9, 2005

(51) Int. Cl. H04Q 5/22

(52) U.S. Cl. 340/10.41; 340/539.22

(57) ABSTRACT

An embodiment including a radio frequency identification system/RFID transponder or tag, and the interface must be able to receive measuring signals from the analog measuring device(s) or sensor module(s). The radio frequency identification device and the interface are integrated as a single die. This single die is configured to not only transmit typical RFID signals, but also the indicative value from the analog measuring device(s) to the interrogator or reader, and then, becomes human readable value.

### TECHNICAL FIELD OF THE INVENTION

This invention relates to systems and methods for performing wireless communication and monitoring parameters of sensor units/devices. This invention also relates to the radio frequency identification devices, sensors, and communicated interfaces between radio frequency identification device(s) and sensor(s).

### BACKGROUND OF THE INVENTION

Electronic identification devices, such as radio frequency identification devices (RFID transponders, or tags), are commonly applied in the current market. For example, these devices are typically used for inventory tracking, entry checking, animal tracking, etc. The electronic identification devices can be stored with unique IDs and can distinguish different single objects or grouped objects. The interrogator or reader may communicate with electronic identification devices, such as transponders, or tags, through radio-frequency (RF) signals produced by an RF transmitter circuit. Using this method, an interrogator or reader can transmit commands to the transponder or tag. On the other hand, an interrogator or reader can also receive encoded data from the transponder or tag.

One of presently available electronic identification devices (RFID transponders, or tags) utilizes a magnetic coupling system. The device typically has no direct power supply, also referred to as a passive electronic identification system, which results in a relatively small package size. However, such electronic identification systems have relatively short ranges because they are limited by the power transmitting efficiency of the magnetic field used to supply power to the devices and to communicate with the devices. Another type of electronic identification device is the active electronic identification systems. Because active electronic identification devices have their own power supply, they do not need close proximity to an interrogator or reader to receive power via magnetic field. Similarly, the active electronic identification systems can communicate with interrogators or readers at a longer distance than passive devices.

An analog measuring device or a sensor is a device that detects, or senses, a signal or physical condition. There are many types of sensors, such as the light sensor, sound sensor, temperature sensor, heat sensor, radiation sensor, electrical resistance sensor, electrical current sensor, electrical voltage sensor, electrical power sensor, magnetism sensor, pressure sensor, gas sensor, liquid flow sensor, motion sensor, orientation sensor, proximity sensor, distance sensor, whisker sensor, biological sensor, chemical sensor, etc. Sensors are either used for direct indicating (e.g. a mercury thermometer or electrical meter) or for pairing with an indicator, such as an analog to digital converter, so that the sensed value becomes humanly readable. However, it is hard to identify every single sensor, especially when massive sensors are implemented to measure the same parameter. Another disadvantage is to communicate between massive sensors. Basically, each sensor has to be connected to fixed wire and, then coupled to a peripheral interface to communicate and to collect measuring data. Obviously, these huge networking infrastructures will cost much labor and money.

By associating with the radio frequency identification device/RFID transponder, or tag, and the analog measuring device or sensor module, each analog measuring device has its unique ID, which can identify and delivery indicative value by applying wireless communication methodology. Moreover, depending on the power consumption of the RFID tags and the analog measuring device, the applicants have the option of operating the radio frequency identification device/RFID transponder, or tag, actively or passively.

However, an interface issue must be overcome. The interface is configured to communicate from the analog measuring device or sensor module to the RFID transponder, or tag.

In the embodiment of the present invention, the universal radio frequency identification sensing system has three different interface architectures.

Architecture 1 (FIG. 2) has an internal D/A converter designed to perform the A/D function with a comparator and successive-approximation algorithm executed by the digital control unit. The n bits resolution of the built-in internal D/A determines the maximum resolution of the A/D function. The number of bits of A/D resolution can be configured via the reader (interrogator) with a protocol and be stored within the universal radio frequency identification sensing system's memory, such that the successive-approximation algorithm does not need to go all the way though to n bits of resolution.

Architecture 2 (FIG. 6) has an internal A/D converter. The advantage of a built-in internal A/D converter is that the user does not need to look for an external A/D as long as user is satisfied with the resolution this internal A/D provides. This internal A/D converter can always be upgraded by the universal radio frequency identification sensing system if a better A/D resolution is needed.

Architecture 3 (FIG. 7) has a parallel digital bus interface with n digital inputs. It can receive digital data from sensors up to the most significant n bits for resolution.

### SUMMARY OF THE INVENTION

The present invention provides several apparatus and methods of interfaces, which, integrated as a single die with radio frequency identification device, is configured to create a communicated channel between the radio frequency identification device and the analog measuring device or sensor module.

The single die as a universal radio frequency identification sensing system is comprised of a radio frequency identification device, which provides a signal to identify the device in response to an interrogation signal. In addition, the single die further comprises the interface is coupled to the output(s) of analog measuring device or sensor module. The universal radio frequency identification sensing system is configured and embodied to transmit an indicative signal of an analog measuring device by using RFID communication method.

The above advantages and benefits of the present invention will be explained through references to the following detailed descriptions and appended sheets of drawings.

### BRIEF DESCRIPTION OF THE DRAWINGS

These and other features and advantages will become more apparent when taken in conjunction with drawings in which:

FIG. 1 is a top block diagram showing an analog measuring device or a sensor module, a host, an interrogator, or a reader, and a universal radio frequency identification sensing system embodying the invention.

FIG. 2 is a circuit schematic of circuitry in accordance with one embodiment of the invention.

FIG. 2A is a circuit schematic of circuitry in accordance with an alternative embodiment of the invention referred to FIG. 2.

FIG. 3 illustrates the circuit schematic of a universal radio frequency identification sensing system, which supports the circuit of FIG. 2.

FIG. 4 is a flow chart for the directional transmitting operation supporting the circuit of FIG. 2 according to one embodiment of the invention.

FIG. 5 is a flow chart for the bi-directional transmitting operation supporting the circuit of FIG. 2 according to one embodiment of the invention.

FIG. 6 is a circuit schematic of circuitry in accordance with one alternative embodiment of the invention.

FIG. 6A is a circuit schematic of circuitry in accordance with an alternative embodiment of the invention referred to FIG. 6.

FIG. 7 is a circuit schematic of circuitry in accordance with one alternative embodiment of the invention.

FIG. 8 illustrates relevant sensor modules associated with the universal RFID system.

### DETAILED DESCRIPTION

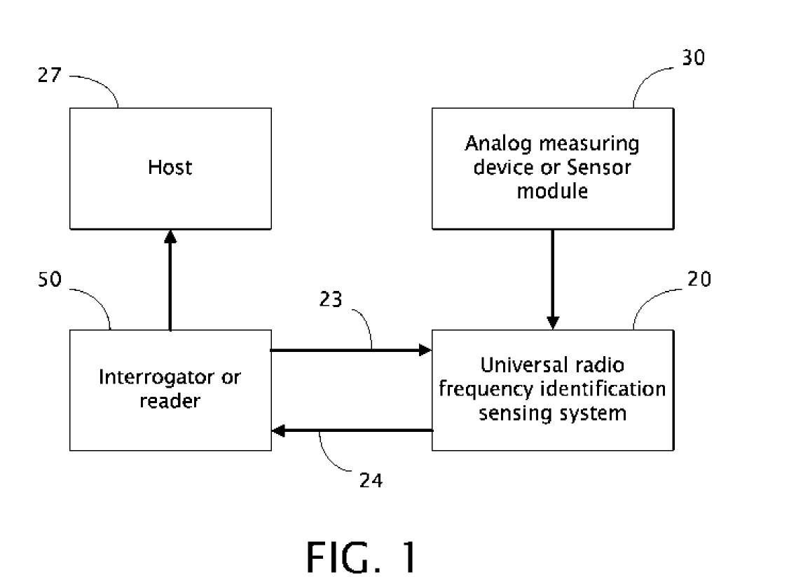

FIG. 1 is a block diagram illustrating a host 27, an interrogator or a reader 50, an analog measuring device or a sensor module 30, and a universal radio frequency identification sensing system 20 in accordance with one embodiment of the invention. The universal radio frequency identification sensing system 20 includes a radio frequency identification device, such as a RFID transponder, or tag, to receive and respond to the wireless interrogation signal 23 from the reader 50. The universal radio frequency identification sensing system 20 further comprises an interface, which is integrated as a single die, coupled to the output(s) of an analog measuring device or a sensor module 30. The interrogator or reader 50 receives the indicative value by wireless communication 24, is transmitted from the universal radio frequency identification sensing system 20, and then transfers it to the host 27 for further applications. The universal radio frequency identification sensing system 20 is the embodiment of the present invention and the following detail description.

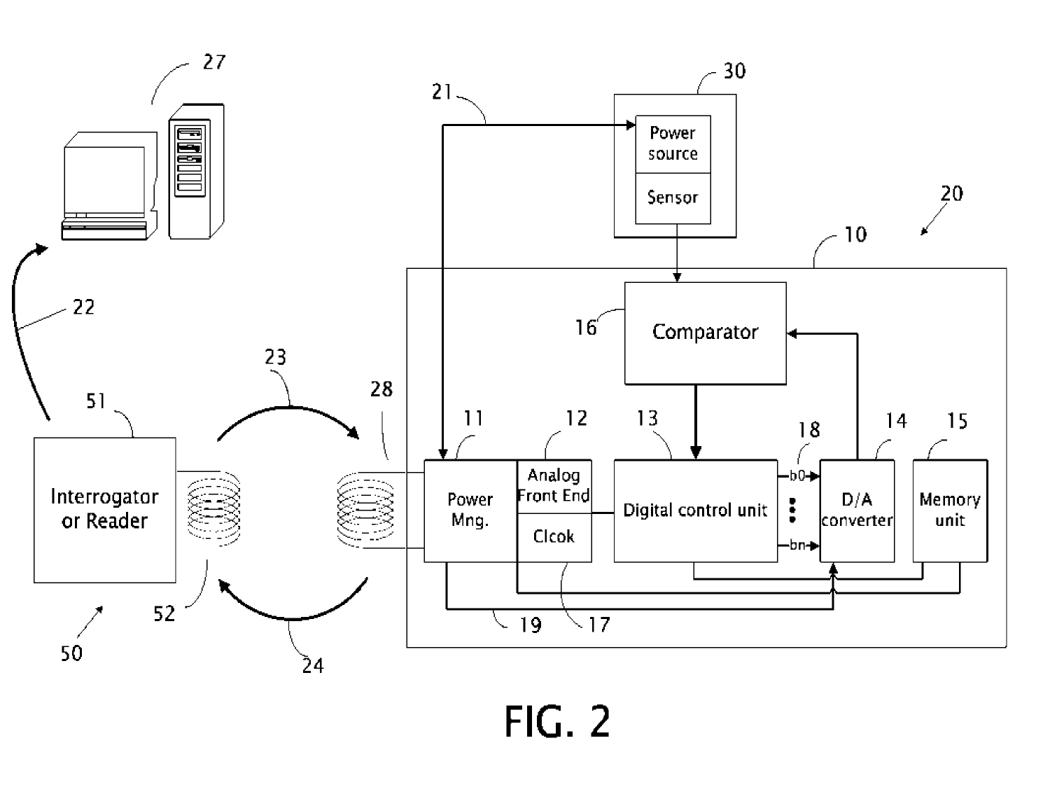

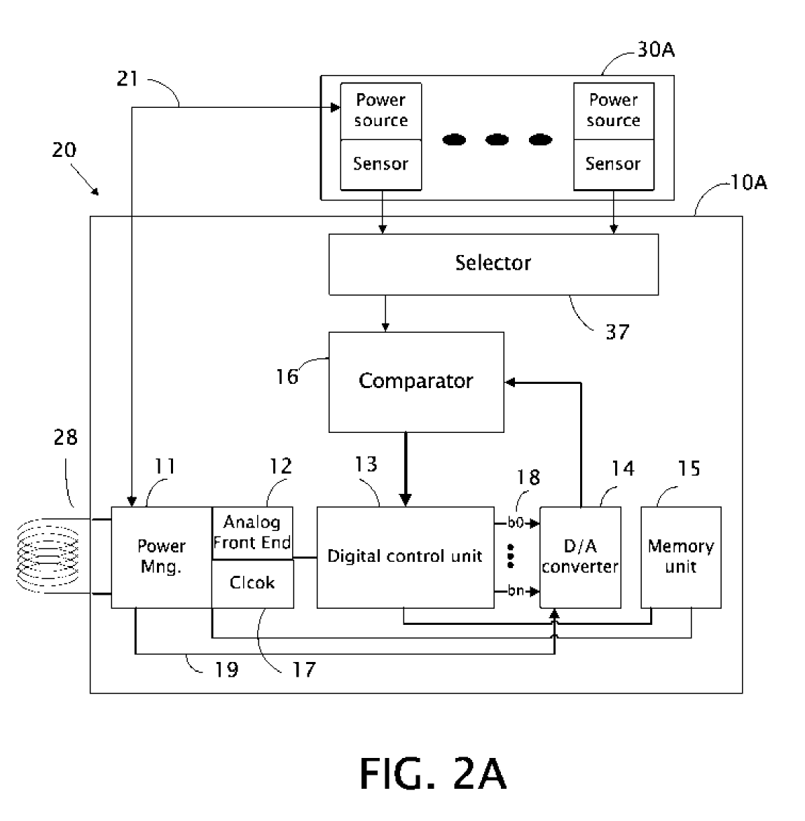

As illustrated in the FIG. 2, a universal radio frequency identification sensing system 20 embodies the present invention, an interrogator or reader 50, and an analog measuring device or sensor 30. The universal radio frequency identification sensing system 20 further includes circuitry as a single die 10 connected to an antenna 28 for wireless radio frequency transmission by the circuitry 10.

A single die 10 has the basic circuit of a RFID transponder, or tag, which includes power management 11, clock 17, analog front end 12, digital control unit 13, and memory unit 15. Generally, the interrogator or reader 50 transmits an interrogation signal or command 23 via an antenna 51. The device 10 receives the incoming signal via an antenna 28. The device 10 communicates with the interrogator or reader 50 by processing the incoming interrogation signal 23 and transmitting the responsive signal 24 via the antenna 28. The responsive signal 24 normally includes the specific data or information that identifies uniquely with any type of particular object. Thus, the responsive signal 24 can identify any type of object that the device 10 is associated with.

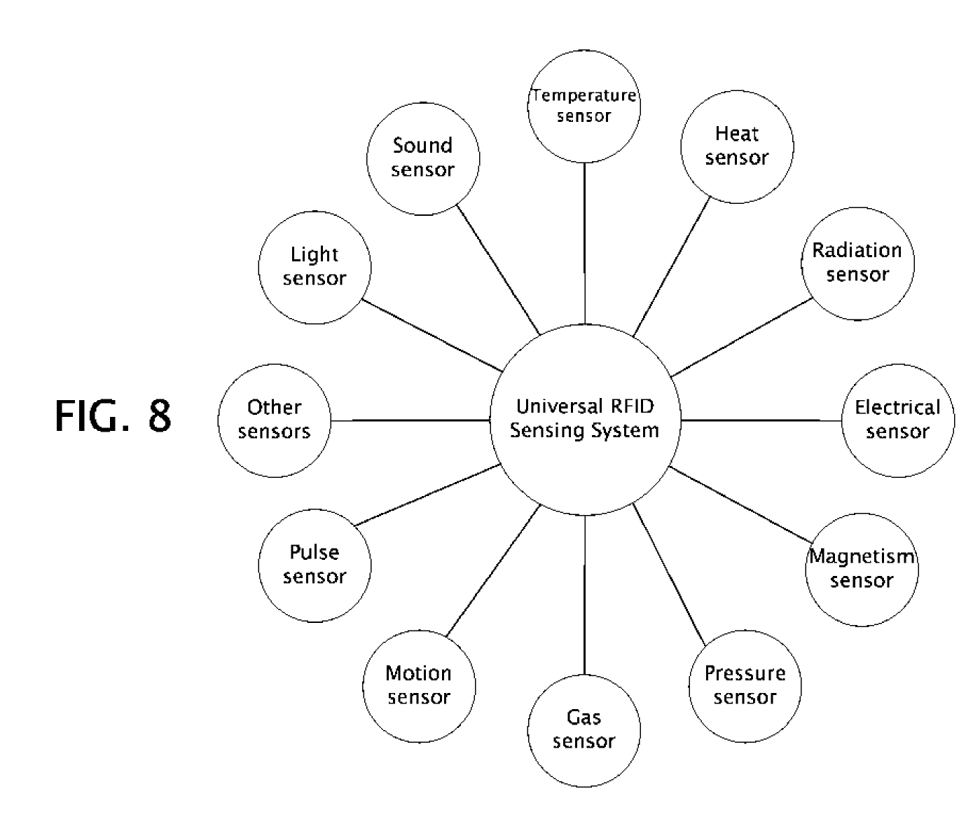

One of the most important inventions of the embodiment is that the responsive signal 24 not only includes a specified data to identify particular associated object, but also includes the indicative value from the particular associated object, which is an analog measuring device or sensor module 30. An analog measuring device or a sensor module 30 could be any type of applications, as shown in the FIG. 8.

A radio frequency identification system is classified into two types, passive and active radio frequency identification system, by determining the propagation of power. The power of passive radio frequency identification system is induced by the magnetic field, which is generated by the interrogator or reader. Similarly, there is no direct power source for the passive radio frequency identification system. On the other hand, the active radio frequency identification system is functional by a direct power source, such as battery. Basically, the universal radio frequency identification sensing system 20 is a passive system and can supply power for the coupled analog measuring device or sensor module 30 through the external connection 21. However, some analog measuring devices or sensor modules consume more power than a universal radio frequency identification sensing system 20 can offer. This way, an analog measuring device or a sensor module may operate as own power source, like a battery. Thus, to take advantage of this point, the single die 10 may operate by using direct stable power from the analog measuring device(s) or sensor module(s) through connected power line 21. By using the power source of the analog measuring device or sensor module 30, a universal radio frequency identification sensing system 20 works as an active radio frequency identification system. The antenna 28 receives a data stream from radio frequency signals 23 only, instead of a data stream and magnetic power receiving together from interrogator and reader 50.

In fact, the invention of the embodiment is suitable for any popularly applied frequency of wireless radio frequency identification system (RFID), such as 125 KHz, 140 KHz, 13.56 MHz, 900 MHz, 2.4 GHz, etc., but the embodiment is not limited to these radio frequencies.

The host or computer 27 will download 22 the collecting data from the interrogators, or readers 50, which includes remote or fixed readers, to do further analysis and data management.

FIG. 2A illustrates the alternative embodiment, referred to FIG. 2, and comprises an extra internal interface, which can be associated with multi-sensor modules 30A. A single die 10A further comprises a selector 37 manipulated by the digital control unit 13, to control the path of the selected analog measuring device or sensor module.

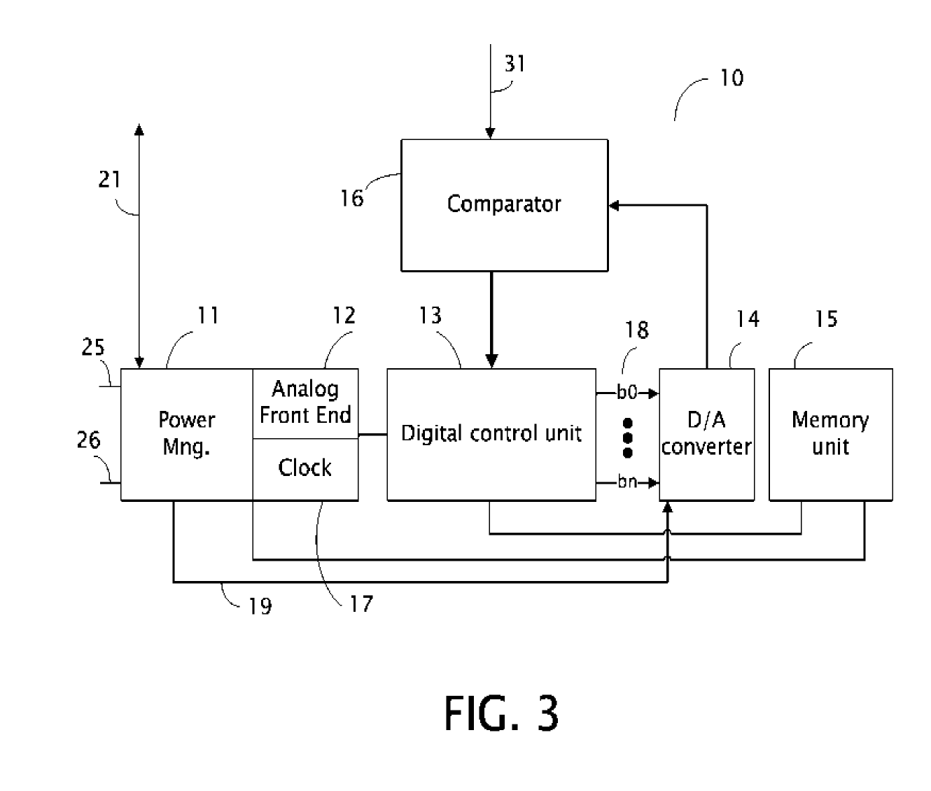

FIG. 3 shows a single die 10, which includes a basic radio frequency identification system, an extra digital to analog converter (hereafter as D/A converter) 14 coupled to digital control unit 13, and an extra comparator 16. The two analog inputs of the comparator 16 are coupled to a D/A converter output and an analog measuring device or sensor module output 31. Furthermore, a comparator 16 output is coupled to the digital control unit 13. The single die 10 includes a clock 17, analog front end 12, a power management unit 11, a digital control unit 13, and a memory unit 15. The clock 17, analog front end 12, and the power management 11 are considered an analog circuitry in the universal radio frequency identification sensing system 20. The power management 11 is configured to manage power distribution. The incoming power source is either induced by the magnetic field which generated by the interrogator or reader 50 through the analog circuitry of a single die 10, or direct stable power from the analog measuring device(s) or sensor module(s). The power management 11 also distributes higher power to memory unit 15 to program and erase memory cell(s).

The analog front end 12 acts as a transceiver, and is configured to receive wireless communication signal 23 from or transmit wireless communication 24 to an interrogator or reader 50 through an external antenna 28. An external antenna 28 is connected to the two external pins or pads 25 and 26 of a single die 10. The interrogator or reader 50 not only transmits and receives signals, but also induces power and clock to the universal radio frequency identification sensing system 20. To take advantage of the power from the analog measuring device(s) or sensor module(s), the single die 10 includes a clock 17, which has an internal clock function when it receives power from the analog measuring device(s) or sensor module(s) directly, without being under the interrogation zone of the reader. Therefore, one of the important inventions of the embodiment, the comprising of a RFID transponder and the analog measuring device(s) becomes a portable analog measuring device, and can also transmit indicative value continually or during a certain period.

In the present invention, the digital control unit 13 not only processes functions of a universal radio frequency identification sensing system 20, but can also determines the correct indicative measuring value from the analog measuring device(s) or sensor modules(s) 30. The integration of a digital control 13, a D/A converter 14, and a comparator 16 is configured to be functional as an analog to digital converter. Theoretically, the indicative value from the output 31 of an analog measuring device(s) or sensor module(s) 30 is one of two comparator's inputs. The other comparator's input is coupled to the output of a D/A converter 14. The digital control unit 13 receives a signal from the output of the comparator and processes by using method of the “Successive-Approximation”. The digital control unit 13 outputs coupled to D/A converter 14 within n bits binary signals, which is b0-bn 18, and determines the resolution of the analog signal. The method of successive-approximation uses fast control logic which requires only n comparisons for an n bits binary result. The power management 11 distributes a voltage source 19 to a D/A converter 14 as a referenced voltage. This referenced voltage 19 is varied and depends on the specification of the sensor module's requirements. Because of the power distribution capability, the referenced voltage 19 also has external connected pin for particular applications. For instance, the power management may only support 5V maximum voltage. Thus, the referenced voltage 19 requires an external voltage source, if an analog measuring device or sensor module 30 requires higher referenced voltage than 5V.

The single die 10 further comprises a memory unit 15 coupled to the digital control unit 13. The memory unit 15 stores the specific unique ID of the universal radio frequency identification sensing system 20 that can be read by the interrogator or reader 50 through the antennas 28 and 51, and the digital control unit 13. Any object will be unique by associating with the single die 10 or the universal radio frequency identification sensing system 20.

The memory unit 15 also stores the configured data of the universal radio frequency identification sensing system 20. The configuration properly includes communication protocols, such as bit-rate, communication mode, and password, etc.

In some applications, the memory unit 15 may store relevant information from the analog measuring device or sensor module 30. The information includes previous or current indicative measuring values, compared parameters of indicative value, and other relevant parameters that are required by the analog measuring or sensor module 30.

The successive-approximation method has been developed for a long time and is outlined in the publication “Digital principles and applications, 5^{th}”, Leach and Malvino, pp. 428-431, incorporated herein by reference. Theoretically, the apparatus includes a successive-approximation register (SAR), a digital to analog converter, and a comparator to perform successive-approximation method. Referring to FIG. 2, a RFID transponder or tag has a digital control unit and plays the role to instead of the SAR. Thus, in the one embodiment of the present invention, an RFID transponder, or tag, is designed to be a universal RFID system by further comprising a digital to analog converter and a comparator as a single die. The successive-approximation converter is effective and accurate to convert an analog signal into binary signals.

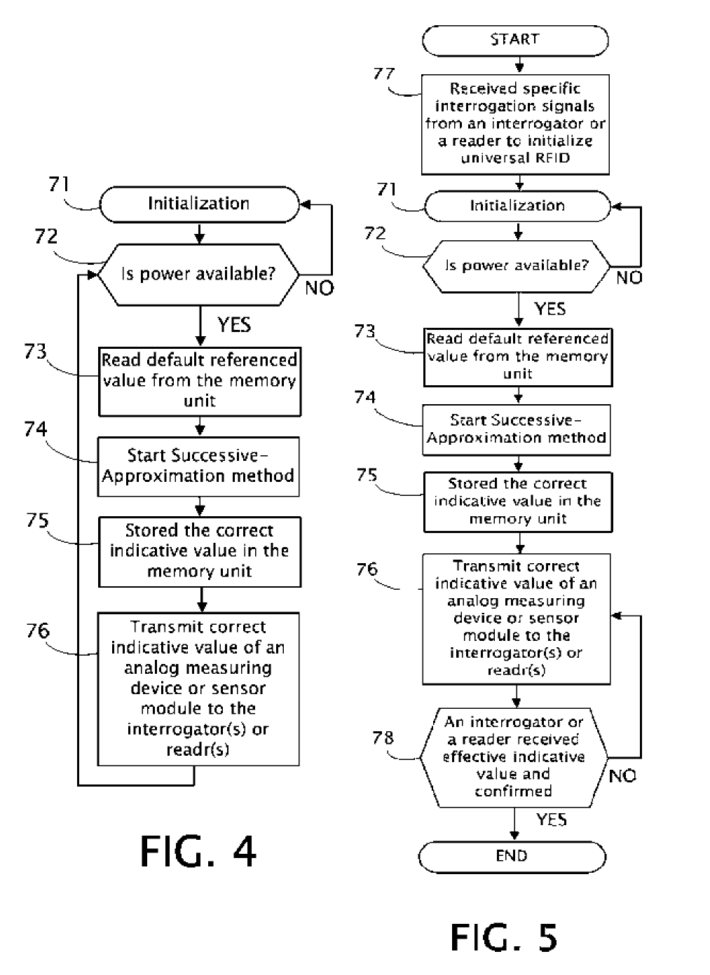

FIG. 4 illustrates the communication protocol of radio frequency identification system associated with the analog measuring device or sensor module. Once a universal radio frequency identification sensing system 20 gains enough power to overcome the trigger point, a single die 10 initializes 71. The single die 10 reads default referenced value from the memory unit 73 and starts executing the successive-approximation method 74 if the power is still available 72. The final and correct indicative value stores in the registers of the digital control unit 13 and the memory unit 15, and transmits 76 the correct measuring indicative value to the interrogator(s) and reader(s) 50. This flow runs continually unless the power is not available.

FIG. 5 illustrates further alternative communication protocol of radio frequency identification system associated with the analog measuring device or sensor module in accordance with an interrogator or a reader. An interrogator or a reader 50 sends a specific command to wake up the particular universal RFID(s) 77. When the universal RFID(s) receives effective command, the single die 10 will execute the same procedures as previously described in the FIG. 4. However, the transmitting indicative value procedure will stop when an interrogator or a reader receives an effective data stream of indicative value and confirmed 78. Similarly, the correct indicative value only transmits one time when the interrogator or reader receives and confirms.

The communication protocol of FIG. 4 is easily distinguishable from FIG. 5. From the universal RFID's point of view, the procedures of FIG. 4 always measure parameters and transmit indicative value automatically and continually, if power is available. In contrast, the procedures of FIG. 5 await effective command, such as answer-on-request, from a reader to activate. Then, the transmission will stop once a reader received effective data stream of indicative value and confirmed.

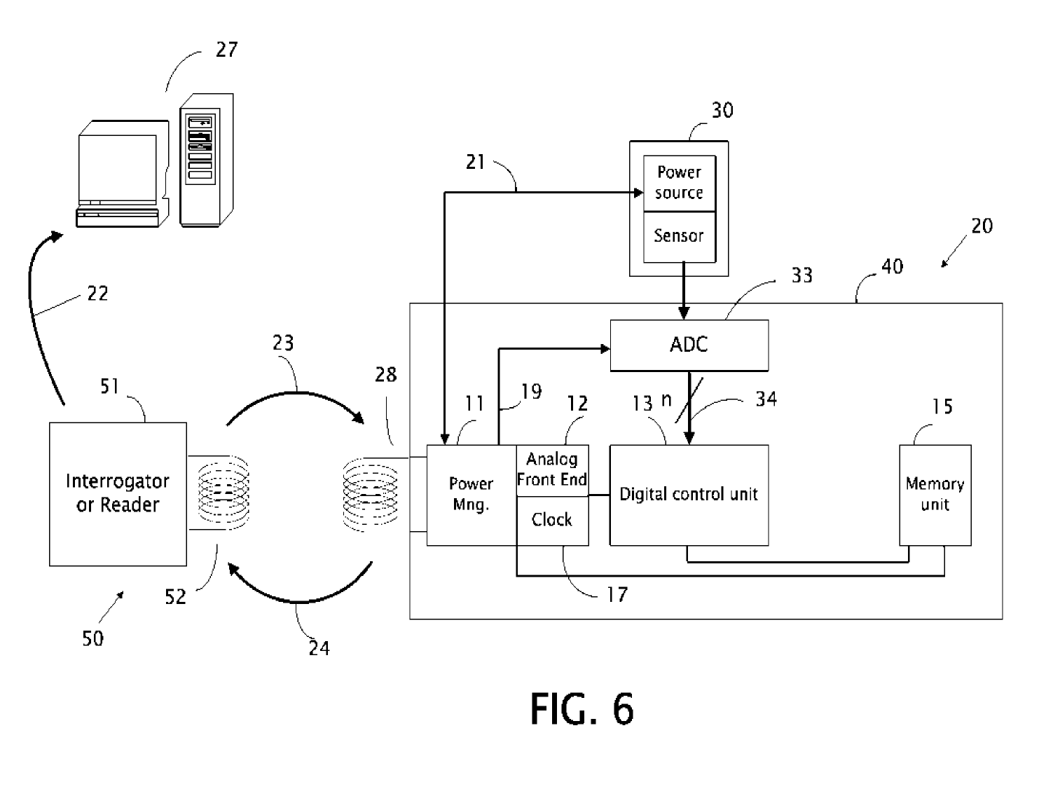

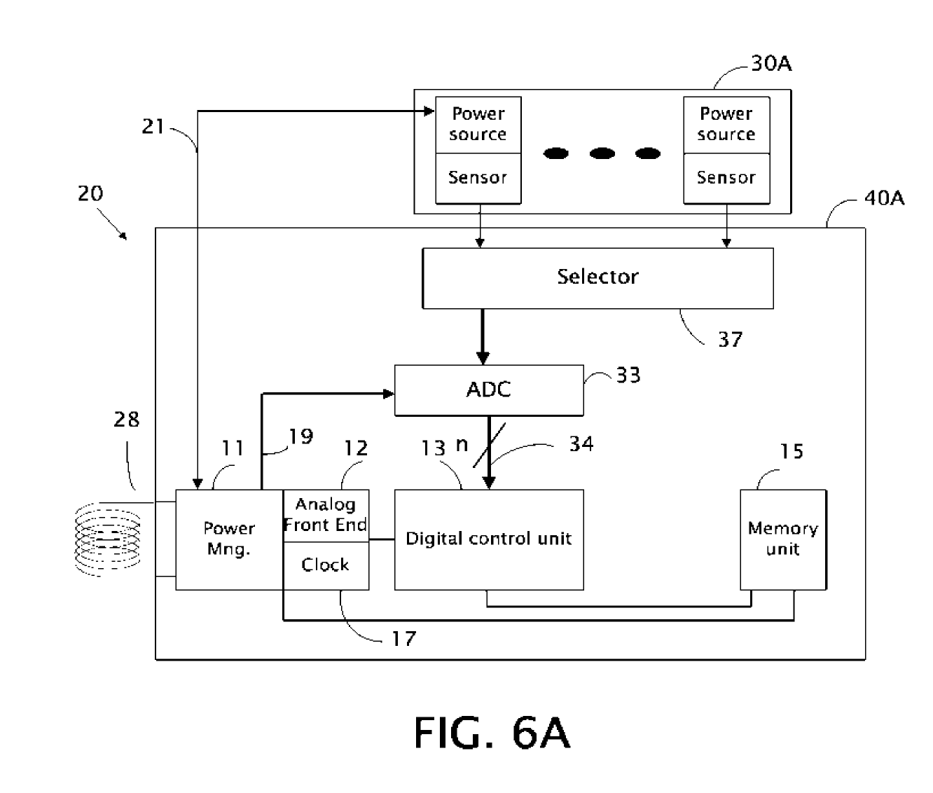

FIG. 6 illustrates another embodiment of the invention, an universal radio frequency identification sensing system 20, which is comprised of a single die 41, an antenna 28 coupled to a single die 41. Instead of a digital to analog converter 14 and a comparator 16 embodying of the invention of FIG. 2, a single die 41 includes an internal analog to digital converter 35, n bits digital outputs 36 coupled to the digital control unit 13 digital inputs. The referenced voltage 19 generated from a power management 11 is coupled to an analog to digital converter 35. Typically, the referenced voltage is equal to the supply voltage when applying it to the analog to digital converter.

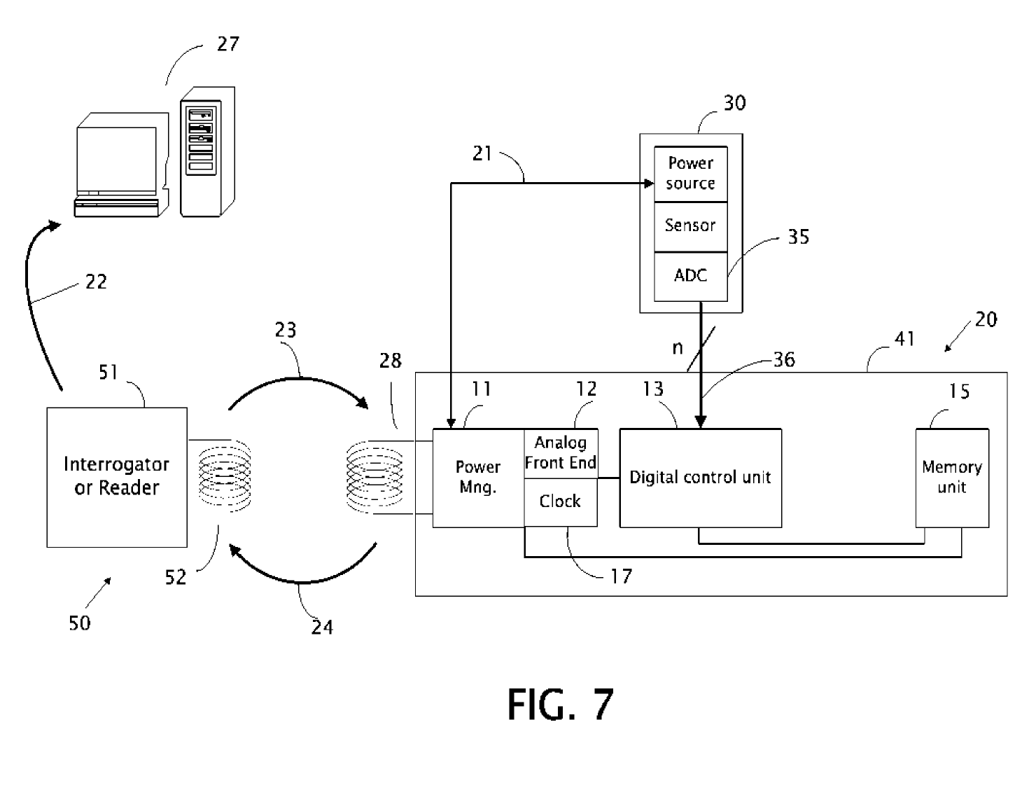

FIG. 6A illustrates alternative embodiment, referred to FIG. 7. It is comprised of an extra internal interface, which can be associated with multi-sensor modules 30A. A single die 40A further comprised of a selector 37 manipulated by the digital control unit 13 can control the path of the selected analog measuring device or sensor module.

Some of the analog measuring devices or sensor modules have binary outputs. Thus, FIG. 7 illustrates the alternative embodiment of the invention, an universal radio frequency identification sensing system 20 that comprises of a single die 40, an antenna 28 coupled to a single die 40, and external n bits bus terminals to be coupled to the n bits binary output 34 of an analog measuring device or sensor module 32. An analog to digital converter, or ADC 33, obviously distinguishes obviously from two different apparatuses of analog measuring devices or sensors, 30 and 32. An analog measuring device or sensor module 32, which comprises of an ADC 33, has n bits binary outputs 34 coupled to the n external pins of a single die 40 and a single die 40 is a typical RFID transponder or tag.

FIG. 8 shows feasible applications. The core of this invention is the universal radio frequency identification sensing system that can be associated with any kind of analog measuring devices or sensor modules. These devices may include a light sensor, sound sensor, temperature sensor, pulse sensor, or many other feasible sensors on the commercial market.

What is claimed is:

1. A universal radio frequency identification sensing system comprising:
an integrated circuit having a single die including a clock as a clock generator, an analog front end as a transceiver, a digital control unit coupled to said clock and said analog front end, a memory unit coupled to said digital control unit, and a power management configured to distribute power; and
said single die further including a digital to analog converter with digital inputs coupled to the outputs of said digital control unit, and an analog output of said digital to analog converter coupled to a comparator first analog input; and
said single die further including a comparator output coupled to the input of said digital control unit, and a comparator second analog input configured to receive an analog measuring device or sensor module output.

2. The universal radio frequency identification sensing system in accordance with claim 1 and further comprising, wherein:
said single die has an external analog input, which is configured to couple any said analog measuring device or sensor module within analog output.

3. The universal radio frequency identification sensing system in accordance with claim 1 and further comprising, wherein:
said single die has external power I/O coupled to said power management and configured to supply power to, or receive power from, said analog measuring device or sensor module.

4. The universal radio frequency identification sensing system in accordance with claim 1 and further comprising, wherein:
said single die has an external input of referenced voltage and to be applied to said digital to analog converter.

5. The universal radio frequency identification sensing system in accordance with claim 1, wherein:
said comparator first analog input is configured to receive a first voltage from said digital to analog converter, and said comparator second analog input is configured to receive a second voltage from said analog measuring device or sensor module, and said comparator provides its digital output signal to indicate the comparing result between said first and second voltages.

6. The universal radio frequency identification sensing system in accordance with claim 1, wherein:
the n bits digital inputs of said digital to analog converter are configured to receive digital signals from said digital control unit, and n bits said digital to analog converter converts digital signals into a single analog output.

7. The universal radio frequency identification sensing system in accordance with claim 1, wherein:
said single die comprised said clock can generate an internal clock when it receives power from said analog measuring device(s) or sensor module(s), instead of the interrogator or reader, and said universal radio frequency identification sensing system works as an active RFID transponder or tag.

8. The universal radio frequency identification sensing system in accordance with claim 1 and further comprising, wherein:
said single die has a selector coupled to said comparator second analog input, and the external analog inputs of said selector coupled to analog output of each said analog measuring device or sensor module.

9. The universal radio frequency identification sensing system in accordance with claim 1, wherein:
said single die has said memory unit with a non-volatile capability to memorize, but it is not limited to, the resolution controlling data of said digital to analog converter, the configuration data, and a number of indicative value of said analog measuring device(s) or sensor module(s), can be used in portable applications.

10. The universal radio frequency identification sensing system in accordance with processing method of claim 1, wherein:
said the embodiment uses successive-approximation method to determine the effective said indicative value of said analog measuring device or sensor module.

11. The universal radio frequency identification sensing system in accordance with communication methods of claim 1, wherein:
said universal radio frequency identification sensing system transmits the effective said indicative value continually when the power is available; and said universal radio frequency identification sensing system transmits the effective said indicative value only one time when receive the effective interrogational commands from, said interrogator or reader, and at the same time, the power is still available.

12. The universal radio frequency identification sensing system in accordance with claim 1, wherein:
said analog measuring device or sensor module being selected from the group consisting of, but not limited to, light sensor, sound sensor, temperature sensor, heat sensor, radiation sensor, electrical resistance sensor, electrical current sensor, electrical voltage sensor, electrical power sensor, magnetism sensor, pressure sensor, gas sensor, liquid flow sensor, motion sensor, orientation sensor, proximity sensor, distance sensor, whisker sensor, biological sensor, and chemical sensor.

13. A universal radio frequency identification sensing system comprising:
an integrated circuit having a single die including a clock as a clock generator, an analog front end as a transceiver, a digital control unit coupled to said clock and said analog front end, a memory unit coupled to said digital control unit, and a power management configured to distribute power; and
said single die further including an analog to digital converter input coupled to the output of an external analog measuring device or sensor module, and the n bits digital outputs coupled to said digital control unit.

14. The universal radio frequency identification sensing system in accordance with claim 13 and further comprising, wherein:
said single die has an external analog input, which is configured to couple any said analog measuring device or sensor module within analog output.

15. The universal radio frequency identification sensing system in accordance with claim 13 and further comprising, wherein:
said single die has external power I/O coupled to said power management and configured to supply power to, or receive power from, said analog measuring device or sensor module.

16. The universal radio frequency identification sensing system in accordance with claim 13 and further comprising, wherein:
said single die has an external input of referenced voltage and to be applied to said analog to digital converter.

17. The universal radio frequency identification sensing system in accordance with claim 13, wherein:
said single die comprised said clock can generate an internal clock when it receives power from said analog measuring device(s) or sensor module(s), instead of the interrogator or reader, and said universal radio frequency identification sensing system works as an active RFID transponder or tag.

18. The universal radio frequency identification sensing system in accordance with claim 13 and further comprising, wherein:
said single die has a selector coupled to said analog to digital converter input, and the external analog inputs of said selector coupled to analog output of each said analog measuring device or sensor module.

19. The universal radio frequency identification sensing system in accordance with claim 13, wherein:
said single die has said memory unit with a non-volatile capability to memorize, but it is not limited to, the resolution controlling data of said analog to digital converter, the configuration data, and a number of indicative value of said analog measuring device(s) or sensor module(s), can be used in portable applications.

20. The universal radio frequency identification sensing system in accordance with communication methods of claim 13, wherein:
said universal radio frequency identification sensing system transmits the effective said indicative value continually when the power is available; and said universal radio frequency identification sensing system transmits the effective said indicative value only one time when receive the effective interrogational commands from, said interrogator or reader, and at the same time, the power is still available.

21. The universal radio frequency identification sensing system in accordance with claim 13, wherein:
said analog measuring device or sensor module being selected from the group consisting of, but not limited to, light sensor, sound sensor, temperature sensor, heat sensor, radiation sensor, electrical resistance sensor, electrical current sensor, electrical voltage sensor, electrical power sensor, magnetism sensor, pressure sensor, gas sensor, liquid flow sensor, motion sensor, orientation sensor, proximity sensor, distance sensor, whisker sensor, biological sensor, and chemical sensor.

22. A universal radio frequency identification sensing system comprising:
an integrated circuit having a single die including a clock as a clock generator, an analog front end as a transceiver, a digital control unit coupled to said clock and said analog front end, a memory unit coupled to said digital control unit, and a power management configured to distribute power.

23. A universal radio frequency identification sensing system in accordance with claim 22 and further comprising, wherein:
said single die has external n bits digital inputs, which are configured to couple any said analog measuring device or sensor module within digital outputs.

24. The universal radio frequency identification sensing system in accordance with claim 22 and further comprising, wherein:
said single die has external power I/O coupled to said power management and configured to supply power to, or receive power from, said analog measuring device or sensor module.

25. The universal radio frequency identification sensing system in accordance with claim 22, wherein:
said single die comprised said clock can generate an internal clock when it receives power from said analog measuring device(s) or sensor module(s), instead of the interrogator or reader, and said universal radio frequency identification sensing system works as an active RFID transponder or tag.

26. The universal radio frequency identification sensing system in accordance with claim 22, wherein:
said single die has said memory unit with a non-volatile capability to memorize, but it is not limited to, the resolution controlling data of said external n bits digital inputs, the configuration data, and a number of indicative value of said analog measuring device(s) or sensor module(s), can be used in portable applications.

27. The universal radio frequency identification sensing system in accordance with communication methods of claim 22, wherein:
said universal radio frequency identification sensing system transmits the effective said indicative value continually when the power is available; and said universal radio frequency identification sensing system transmits the effective said indicative value only one time when receive the effective interrogational commands from, said interrogator or reader, and at the same time, the power is still available.

28. The universal radio frequency identification sensing system in accordance with claim 22, wherein:
said analog measuring device or sensor module being selected from the group consisting of, but not limited to, light sensor, sound sensor, temperature sensor, heat sensor, radiation sensor, electrical resistance sensor, electrical current sensor, electrical voltage sensor, electrical power sensor, magnetism sensor, pressure sensor, gas sensor, liquid flow sensor, motion sensor, orientation sensor, proximity sensor, distance sensor, whisker sensor, biological sensor, and chemical sensor.
